(19) United States
(12) Patent Application Publication
(10) Pub. No.: US 2013/0205334 A1
(43) Pub. Date: Aug. 8, 2013

(54) METHOD AND APPARATUS FOR PROVIDING SUPPLEMENTARY INFORMATION ABOUT CONTENT IN BROADCASTING SYSTEM

(71) Applicants: Jung Hak KIM, Daejeon-si (KR); Soon Choul KIM, Daejeon-si (KR); Seung Chul KIM, Daejeon-si (KR); Bum Suk CHOI, Daejeon-si (KR); Jeoung Lak HA, Daejeon-si (KR); Young Ho JEONG, Daejeon-si (KR); Jin Woo HONG, Daejeon-si (KR)

(72) Inventors: Jung Hak KIM, Daejeon-si (KR); Soon Choul KIM, Daejeon-si (KR); Seung Chul KIM, Daejeon-si (KR); Bum Suk CHOI, Daejeon-si (KR); Jeoung Lak HA, Daejeon-si (KR); Young Ho JEONG, Daejeon-si (KR); Jin Woo HONG, Daejeon-si (KR)

(73) Assignee: Electronics and Telecommunications Research Institute, Daejeon (KR)

(21) Appl. No.: 13/590,382

(22) Filed: Aug. 21, 2012

(30) Foreign Application Priority Data
Feb. 2, 2012 (KR) 10-2012-0010657

(51) Int. Cl. H04N 21/83

(52) U.S. Cl. 725/32

(57) ABSTRACT

A method and apparatus for providing supplementary information about content in a broadcasting system are provided. A method of a reception terminal providing supplementary information about content includes receiving content and metadata, extracting an indicator for indicating whether supplementary information about the content exists or not from the metadata, determining whether the supplementary information about the content exists or not based on the indicator, outputting the supplementary information about an appearance element of the content in association with the content based on the metadata, accessing a server for providing the supplementary information about the to appearance element, based on the metadata when an instruction to download the supplementary information about the appearance element is received, and downloading the supplementary information about the appearance element from the server and storing the downloaded supplementary information.

### CROSS-REFERENCE TO RELATED APPLICATIONS

This application claims the benefit of priority of Korean Patent Application No. 10-2012-0010657 filed on Feb. 2, 2012, all of which is incorporated by reference in its entirety herein.

### BACKGROUND OF THE INVENTION

1. Field of the Invention

The present invention relates to a broadcasting system and, more particularly, to a method and apparatus for providing supplementary information about content in a broadcasting system.

2. Related Art

The existing broadcasting system is configured to simply transfer a program provided by a broadcasting station and supplementary information related to the program to a viewer. For this reason, in the existing broadcasting system, it is not easy for a viewer to obtain contents of a broadcasting program while viewing the broadcasting program or desired supplementary information related to an element of the contents.

In contrast, since an Operating System (OS) and an Internet access function are embedded in recent smart TV, not only real-time broadcasting provided through conventional terrestrial waves or a cable, but also various types of contents that may be provided through the Internet, such as Video On Demand (VOD), game, search, convergence and intelligent service may be used. Accordingly, unlike in the existing broadcasting system, a viewer may easily obtain supplementary information related to a broadcasting program through the Internet access function embedded in the smart TV.

Meanwhile, supplementary information provided by recent smart TV is chiefly constructed in a form, such as a banner or a web page. Accordingly, a broadcasting screen reduces or disappears because a banner for displaying supplementary information shields a part of the broadcasting screen or the web page is outputted to a screen in order to provide supplementary information during broadcasting.

However, factors to hinder a broadcasting program or moving picture service must be minimized because priority is given to content in the broadcasting program or to moving picture service. Accordingly, there is a need for a method of preventing supplementary information related to content, such as broadcasting or a moving image, from shielding the viewing of a content program when providing the supplementary information to a viewer. Furthermore, there is a need for a method of smoothly using a remote controller because a viewer who uses a medium, such as TV, commonly uses the remote controller when using supplementary information related to a broadcasting program.

### SUMMARY OF THE INVENTION

An object of the present invention is to provide a method and apparatus for providing supplementary information about an appearance element of content in association with the content in an environment in which broadcasting or moving picture content is provided.

An embodiment of the present invention relates to a method of a reception terminal providing supplementary information about content. The method includes receiving content and metadata, extracting an indicator for indicating whether supplementary information about the content exists or not, from the metadata, determining whether the supplementary information about the content exists or not based on the indicator, outputting the supplementary information about an appearance element of the content in association with the content based on the metadata, accessing a server for providing the supplementary information about the appearance element based on the metadata when an instruction to download the supplementary information about the appearance element is received, and downloading the supplementary information about the appearance element from the server and storing the downloaded supplementary information.

Outputting the supplementary information about the appearance element of the content may include outputting indication information for indicating that the supplementary information about the appearance element exists in association with the content, based on the metadata, and outputting brief supplementary information about the appearance element and connection information from which detailed supplementary information about the appearance element is downloadable, when the indication information is received.

The indication information may comprise a graphic object including information to identify the appearance element.

The indication information may be overlaid with any one part of the appearance element and outputted.

The brief supplementary information and the connection information may be outputted to any one of top, bottom, right, and left regions of an output screen of the content.

The method may further include outputting an indication informing whether or not to download the supplementary information when the content is finished.

The method may further include outputting the supplementary information according to whether an instruction to output the downloaded supplementary information exists or not.

The metadata may include appearance element association information for providing the supplementary information about the appearance element in association with the content.

The appearance element association information may include at least one of identifier (ID) information about the content, an indicator informing whether the supplementary information about the content exists or not, frame information and time information about the content, scene information about the content, ID information about the appearance element, name information about the appearance element, brief supplementary information about the appearance element, connection information from which detailed supplementary information about the appearance element is downloadable, category information about the supplementary information of the appearance element, and position information about the appearance element.

Another embodiment of the present invention relates to a transmission method for providing supplementary information about content in a broadcasting system. The transmission method includes writing metadata including appearance element association information for providing supplementary information about an appearance element of content in association with the content, producing the supplementary information about the appearance element based on the metadata, and transmitting the content and the metadata.

The appearance element association information may include at least one of identifier (ID) information about the content, an indicator informing whether the supplementary information about the content exists or not, frame information and time information about the content, scene information about the content, ID information about the appearance element, name information about the appearance element, brief supplementary information about the appearance element, connection information from which detailed supplementary information about the appearance element is downloadable, category information about the supplementary information of the appearance element, and position information about the appearance element.

The metadata may be transmitted in any one of a form multiplexed with the content, a streaming form, and a data file form.

In still another embodiment of the present invention relates to a reception terminal for providing supplementary information about content. The reception terminal includes a reception unit for receiving content and metadata, a processor for extracting an indicator for indicating whether supplementary information about the content exists or not, from the metadata and determining whether the supplementary information about the content exists or not based on the indicator, an output unit for outputting the supplementary information about an appearance element of the content in association with the content based on the metadata, and a memory unit for accessing a server for providing the supplementary information based on the metadata when an instruction to download the supplementary information about the appearance element is received, downloading the supplementary information from the server, and storing the downloaded supplementary information.

The output unit may output indication information for indicating that the supplementary information about the appearance element exists, in association with the content based on the metadata.

The output unit may output brief supplementary information about the appearance element and connection information from which detailed supplementary information about the appearance element is downloadable, when the indication information is received.

The indication information may comprise a graphic object including information to identify the appearance element.

The indication information may be overlaid with any one part of the appearance element and outputted.

The brief supplementary information and the connection information may be outputted to any one of top, bottom, right, and left regions of an output screen of the content.

The output unit may output an indication informing whether or not to download the supplementary information when the content is finished.

The output unit may output the supplementary information according to whether to an instruction to output the downloaded supplementary information exists or not.

### BRIEF DESCRIPTION OF THE DRAWINGS

FIG. 1 is a diagram schematically showing the configuration of a broadcasting system for providing content and supplementary information about the content according to an embodiment of the present invention;

FIG. 2 is a flowchart illustrating a process of obtaining position information about an appearance element of content according to an embodiment of the present invention;

FIG. 3 is a flowchart illustrating a transmission method for providing supplementary information about content in the broadcasting system according to an embodiment of the present invention;

FIG. 4 is a flowchart illustrating an operation of a reception terminal in the broadcasting system for providing supplementary information about content according to an embodiment of the present invention;

FIG. 5 is a block diagram showing a construction of the reception terminal in the broadcasting system for providing supplementary information about content according to an embodiment of the present invention; and

FIG. 6 is a diagram schematically showing screens of the reception terminal in which pieces of supplementary information about appearance elements of content are provided according to an embodiment of the present invention.

### DESCRIPTION OF EXEMPLARY EMBODIMENTS

Hereinafter, some embodiments of the present invention are described in detail with reference to the accompanying drawings in order for those skilled in the art to be able to readily implement the invention. Furthermore, the present invention is not limited to the following embodiments and may be modified in various ways within the scope of the technical spirit of the present invention.

Elements described in this specification may include additional elements other than elements to be described later, at need, and a detailed description of parts not directly related to the present invention or redundant parts is omitted. Furthermore, when it is said that any part includes (or comprises) any element, it means the part does not exclude other elements and may further include other elements.

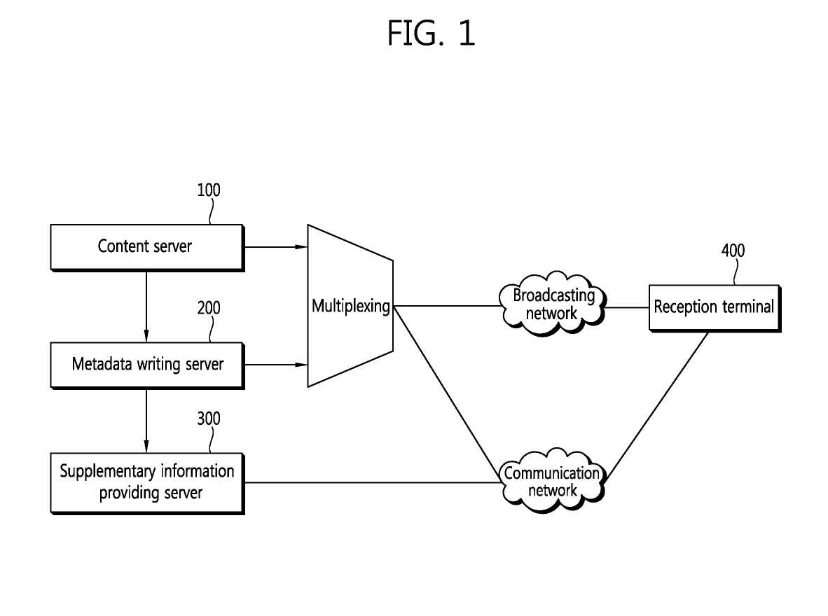

FIG. 1 is a diagram schematically showing the configuration of a broadcasting system for providing content and supplementary information about the content according to an embodiment of the present invention.

Referring to FIG. 1, the broadcasting system according to the embodiment of the present invention includes a content server 100, a metadata writing server 200, a supplementary information providing server 300, and a reception terminal 400. Here, content, metadata, and supplementary information related to the content may be transmitted and received over a broadcasting network or a communication network.

The content server 100 is an apparatus for providing content and transmits content to the reception terminal 400 over a broadcasting network or a communication network.

The content is produced by a content provider. The content may include, for example, real-time relay content, such as news and sports relay broadcasting which transfers information in real time, and previously produced content, such as dramas, movies, entertainment, and documentaries which have been produced and edited before being provided to a content user (hereinafter referred to as a ‘viewer’).

When the content is transmitted from the content server 100 to the reception terminal 400, various types of supplementary information related to the content may be provided. The supplementary information includes various types of information related to appearance elements, such as characters, places, buildings, and things that appear in the content.

For example, when news broadcasting content is provided, information related to characters, such as an anchor person and a reporter who appear in the news, or supplementary information related to various words transferred through the news may be provided along with the news broadcasting. When sports relay broadcasting content, such as baseball or soccer, is provided, information related to characters, such as players, judges, and commentators who appear in the sports broadcasting, or supplementary information related to indirect advertisements that may be transferred to viewers through the sports broadcasting may be provided along with the sports relay broadcasting. When previously produced content, such as dramas or movies, is provided, various types of supplementary information related to appearance elements, such as characters, places, buildings, and things which appear in the previously produced content, may be provided along with the previously produced content.

In order to provide content and various types of supplementary information related to the content as described above, not only the content, but also content necessary to provide the supplementary information must be produced. Furthermore, metadata necessary to provide the supplementary information about the content must be produced in association with the content.

Accordingly, the content server 100 transfers the content to the metadata writing server 200 so that the metadata writing server 200 writes metadata for the content. In an embodiment, a content provider may directly provide the content to the metadata writing server 200 so that the metadata writing server 200 writes the metadata.

The metadata writing server 200 writes metadata necessary to provide the supplementary information about the content. That is, the metadata writing server 200 receives the content from the content server 100 or a content provider and generates the metadata including pieces of information which are necessary to provide supplementary information about appearance elements of the content based on the content.

For example, when content transmitted to the reception terminal 400 is outputted on a screen of the reception terminal 400, the metadata writing server 200 may write metadata including information that enables supplementary information to be outputted in association with the content.

More particularly, in order to provide supplementary information, metadata may include the following pieces of information.

The metadata includes information that identifies content. For example, the metadata may include a content number or an identifier (ID).

The metadata includes information informing whether supplementary information about content exists or not. For example, the metadata may include an indicator indicating whether supplementary information exists or not.

The metadata includes frame information and time information. The frame information is information about each of still images that constructs content, such as broadcasting or a moving picture, and it includes sequence of still images or an identifiable number. The time information indicates a specific point of time from the start point of content.

For example, appearance elements, such as characters, background places, buildings, and things, appear in content, such as a movie or drama broadcasting. A appearance element, that is, the subject whose supplementary information will be provided exists in the appearance elements. In order to output the subject whose supplementary information will be provided on a screen of the reception terminal 400, such as TV, information informing that the subject is related to which one of still images forming content and that a relevant still image must be outputted at which point of time from the start point of the content is necessary.

The metadata includes scene information. In case of broadcasting or moving picture content, image frames corresponding to a scene formed of a background, a place, a character, or a thing are commonly maintained for a specific time with no a sudden change in the frames. Accordingly, image frames corresponding to a scene that is fixed or rarely changed for a specific time may be grouped. The scene information includes a number or ID for distinguishing the groups from one another.

The metadata includes information for identifying appearance elements of content. For example, a number or ID for identifying each of appearance elements appearing in content, such as characters, places, buildings, and things.

The metadata includes the name of an appearance element, brief supplementary information about an appearance element, and connection information, such as a Uniform Resource Identifier (URI) or a Uniform Resource Locator (URL) on which detailed supplementary information about an appearance element may be further obtained.

In this specification, the brief supplementary information refers to brief information, such as attribute information about an appearance element, a name of a character, a name of a place, a product name, and a description of a brief memo form. The detailed supplementary information refers to simple information about an appearance element and specific information about an appearance element, such as pertinent news or pertinent advertising.

The metadata includes category information indicating that supplementary information about an appearance element belongs to what category. For example, the supplementary information may be provided in various forms, such as simple information, pertinent news, and pertinent advertising about an appearance element. The category information classifies the pieces of supplementary information according to categories.

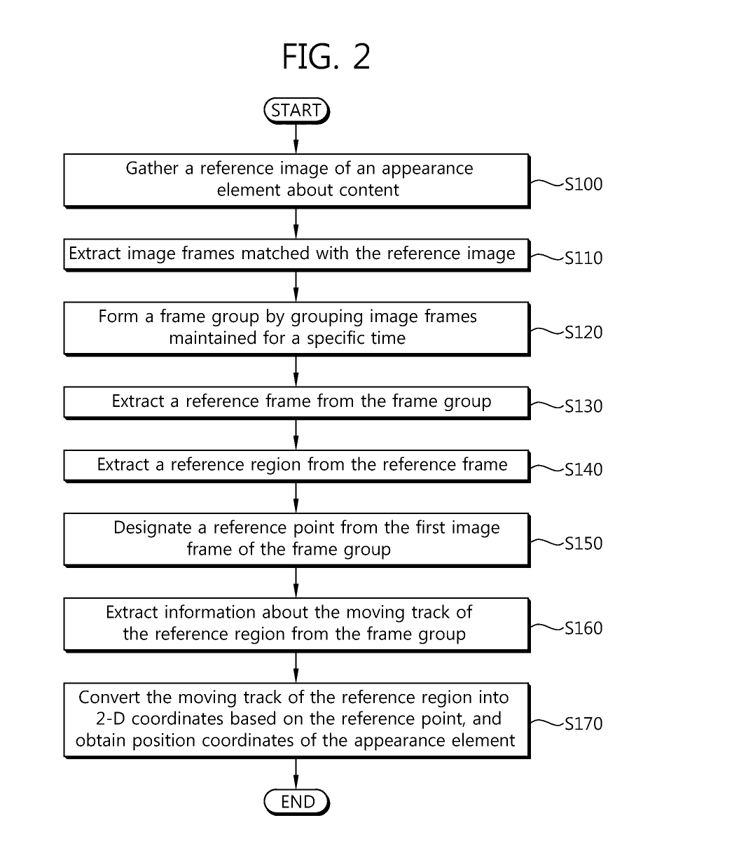

The metadata includes position information about an appearance element of content, that is, information about the position of a part where the appearance element is outputted on a screen of the reception terminal 400, such as TV. A process of extracting the position information about the appearance element from content is described later with reference to FIG. 2.

The metadata including the pieces of information, that is, appearance element association information necessary to provide supplementary information about an appearance element of content may be written by the metadata writing server 200, multiplexed with content, and then transmitted to the reception terminal 400 over a broadcasting network or a communication network. In an embodiment, the metadata may further include necessary pieces of information in addition to the pieces of information.

The supplementary information providing server 300 produces or gathers various types of supplementary information related to produced content based on the metadata written by the metadata writing server 200 in order to provide supplementary information about the content, and provides the various types of supplementary information to the reception terminal 400.

For example, the supplementary information providing server 300 may produce and provide supplementary information about an appearance element of content in the form of a simple moving image clip having a preview form. The supplementary information providing server 300 may directly provide brief supplementary information or detailed supplementary information about an appearance element to the reception terminal 400 or may provide connection information, such as a URI or URL from which supplementary information may be downloaded through access to another server which provides the supplementary information, to the reception terminal 400. Furthermore, the supplementary information providing server 300 may provide content information, the major scene information about an appearance element of content, and scene information included in the metadata of content. The detailed supplementary information, the content information, and the major scene information may be produced and provided in a document form, such as an Extensible Markup Language (XML) or a Hyper Text Markup Language (HTML).

The supplementary information providing server 300 generates or gathers the various types of supplementary information and provides them to the reception terminal 400 over a communication network. In an embodiment, the supplementary information providing server 300 sends supplementary information requested by the reception terminal 400 over a communication network.

The reception terminal 400 receives content from the content server 100 and outputs the received content on its screen. At the same time, the reception terminal 400 outputs supplementary information on its screen in association with the content based on metadata received from the metadata writing server 200.

For example, when extracting frame information and time information from metadata and playing content, the reception terminal 400 may output a graphic object in a frame or play time of content in which a relevant appearance element appears. The graphic object is indication means for enabling a viewer to obtain supplementary information about the appearance element through the reception terminal 400. The graphic object (e.g., an image object including information, such as a number or the alphabet) is outputted in such a manner that it is overlaid with any point of an appearance element that will provide the supplementary information.

The reception terminal 400 may extract ID information about an appearance element from metadata and display a graphic object so that the graphic object is overlaid with an appearance element whose supplementary information will be provided. Furthermore, the reception terminal 400 may allocate ID or number information to each graphic object that is overlaid with each appearance element and display an attribute (e.g., characters, places, buildings, and things) for each appearance element.

The reception terminal 400 may extract position information about an appearance element from metadata and display a graphic object on its screen on the basis of the extracted position information so that the graphic object is overlaid with a position where the appearance element is outputted.

When extracting a name of an appearance element and brief supplementary information about the appearance element from metadata and playing relevant content, the reception terminal 400 may output the name and brief supplementary information of the appearance element when the appearance element appears.

The reception terminal 400 may extract scene information from metadata, access a server that provides supplementary information whenever information about the scene of content is changed, and download brief supplementary information about appearance elements included in the scene. Here, the brief supplementary information may be provided in a document form, such as an XML or HTML, as well as a simple text form.

The reception terminal 400 may extract category information from metadata and display the category of supplementary information about an appearance element.

The reception terminal 400 may extract information about a URI or URL from which detailed supplementary information is provided from metadata, access a relevant supplementary information server, and then download detailed supplementary information.

FIG. 2 is a flowchart illustrating a process of obtaining position information about an appearance element of content according to an embodiment of the present invention. The process of FIG. 2 relates to a process of the metadata writing server 200 of FIG. 1 obtaining a point at which an appearance element is placed from an image frame constructing content and including information about the point in the metadata, when writing metadata.

Hereinafter, a process of obtaining information about the position of one appearance element appearing in content is described. This process may be applied to each of all appearance elements appearing in content.

Referring to FIG. 2, the metadata writing server 200 gathers the reference image of an appearance element at step S100. That is, the metadata writing server 200 gathers the reference image, that is, a basis of the appearance element whose position information will be obtained from content.

The metadata writing server 200 extracts image frames including the appearance element which are matched with the reference image from the content at step S110.

The metadata writing server 200 forms a frame group by grouping image frames whose characters, backgrounds, places, and things are maintained for a specific time without being suddenly changed, from among the extracted image frames, at step S120. For example, the metadata writing server 200 may form a frame group by grouping frames that output the same image for a specific time.

The metadata writing server 200 extracts a reference frame that well represents an appearance element from the image frames within the frame group at step S130.

The metadata writing server 200 extracts a reference region where the appearance element is placed from the reference frame at step S140.

The metadata writing server 200 designates the 2-D coordinates of any one point of a region where the appearance element is placed in the first image frame of the frame group as a reference point at step S150. For example, the metadata writing server 200 may detect the region where the appearance element is placed in the first image frame of the frame group and designate the center point of the detected region as the reference point.

The metadata writing server 200 obtains information about the moving track of the reference region within the frame group by tracking the moving track at step S160. The information about the moving track of the reference region may be obtained by using a feature point extraction scheme. For example, the metadata writing server 200 may search regions of the image frames matching with the reference region extracted from the reference frame by matching the reference frame with the image frames within the frame group. That is, the metadata writing server 200 may extract the information about the moving track of the reference region by tracking the region, matching with the reference region from the first image frame to the last image frame within the frame group.

The metadata writing server 200 converts the moving track of the reference region into the moving path of 2-D coordinates on the basis of the reference point and obtains position coordinates of the region where the appearance element is placed from the image frame at step S170.

A plurality of the frame groups may be formed at step S120. In this case, the steps S130 to S170 are repeatedly performed on each of the frame groups.

The above-described steps may be performed by the metadata writing server 200 when the metadata writing server 200 writes metadata. The position of an appearance element is extracted from a content image on the basis of the information, and the existence or not of supplementary information is displayed on a screen of the reception terminal 400 so that a viewer may obtain the supplementary information.

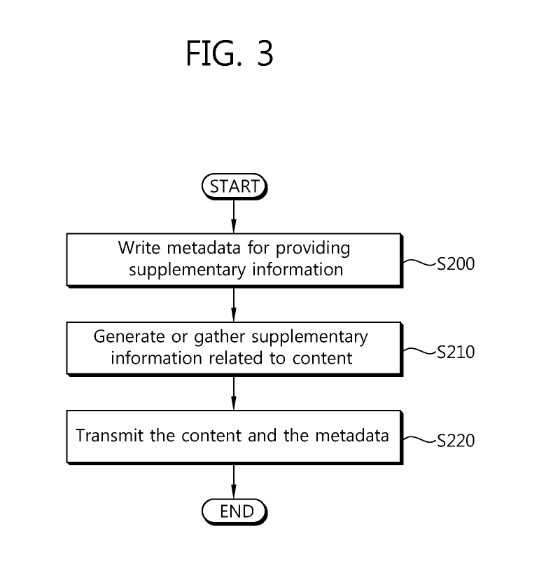

FIG. 3 is a flowchart illustrating a transmission method for providing supplementary information about content in the broadcasting system according to an embodiment of the present invention. The method of FIG. 3 may be performed by the broadcasting system of FIG. 1.

Referring to FIG. 3, metadata necessary to provide various types of supplementary information related to content is written at step S200. That is, the metadata of the content is written in order to provide the various pieces of supplementary information about appearance elements (e.g., characters, background, places, buildings, and things) that appear in the content by analyzing all the contents, a scenario, or an image of broadcasting or moving picture content.

The metadata, as described above with reference to FIG. 1, may include content ID information, an indicator informing the existence or not of supplementary information about content, frame information, time information, scene information, ID information about an appearance element, the name of an appearance element, brief supplementary information about an appearance element, connection information, such as a URI or URL from which detailed supplementary information about an appearance element may be downloaded, category information about supplementary information, and appearance element association information, such as the position information about an appearance element. The metadata writing server 200 writes the metadata so that it includes the pieces of information. In an embodiment, the metadata may be directly written by a content provider or may be written and provided by a third party.

Next, various types of supplementary information related to the content are generated or gathered based on the metadata at step S210. For example, various types of supplementary information, including simple information, pertinent news, and pertinent advertisements related to appearance elements that appear in content, may be gathered and relevant data are stored, or link information about a server that may access a server that provides the relevant data are stored.

Next, the content and the metadata are transmitted to the reception terminal 400 over a broadcasting network or a communication network at step S220. Here, the content and the metadata may be multiplexed and transmitted, or the content and the metadata may be independently transmitted.

For example, if amount of metadata is small or content is relayed in real time, content and metadata may be multiplexed and then transmitted together over a broadcasting network or a communication network.

If amount of metadata is large or specific metadata is sought to be transmitted to a specific person or a specific reception terminal, the metadata may be transmitted in an independent stream form or a data file form, or the specific reception terminal may directly access the content server and download necessary metadata from the content server.

For example, if content, such as real-time broadcasting or Video On Demand (VOD), is streamed from the content server to the reception terminal, metadata may be independently streamed along with the content. Here, the metadata may be streamed to a specific person or a specific reception terminal in a unicast form or may be streamed to a specific person group or a specific reception terminal group in a multi-cast form. In an embodiment, if content is provided in a Digital Video Disk (DVD) form, metadata may be provided in a form multiplexed with content or in an independent file form.

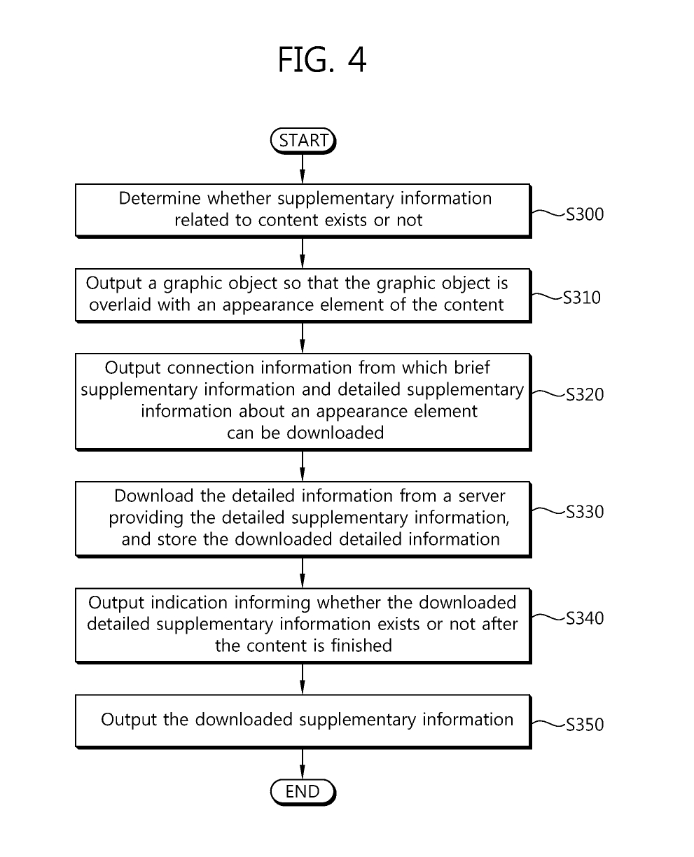

FIG. 4 is a flowchart illustrating an operation of the reception terminal 400 in the broadcasting system for providing supplementary information about content according to an embodiment of the present invention. The operation of FIG. 4 may be performed by the reception terminal 400 of FIG. 1.

Referring to FIG. 4, the reception terminal receives content and metadata, and extracts an indicator indicating whether supplementary information about the content exists or not, from the metadata. Whether the supplementary information about the content exists or not is determined on the basis of the extracted indicator at step S300. If the indicator indicates that the supplementary information exists, the reception terminal may enable a viewer to determine whether to output the supplementary information in association with the content. For example, means (e.g., an input button image) for receiving indication information from a viewer may be inserted into the bottom of a screen of the reception terminal and provided.

Next, the reception terminal outputs indication information, indicating that supplementary information about an appearance element of the content exists in association with the content, based on the metadata at step S310.

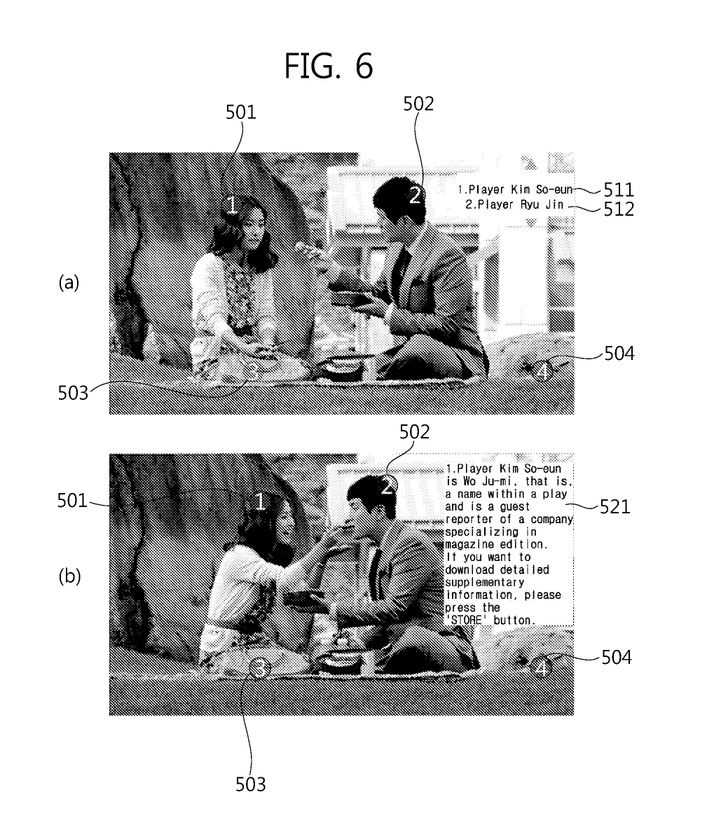

More particularly, when an instruction to output the supplementary information is received from a viewer through a device, such as a remote controller, a keyboard, or a mouse, the reception terminal analyzes metadata and outputs the metadata on its screen so that specific graphic objects (see 501 to 504 of FIG. 6(a)) are overlaid on appearance elements of the content whose supplementary information will be provided. Furthermore, the reception terminal may output pieces of brief supplementary information (see 511 and 512 of FIG. 6(a)), such as attribute information, the names of characters, the name of a place, and product names for a specific appearance element, in an area of the screen or near the specific appearance element, along with the graphic objects. Accordingly, a viewer may know that the supplementary information exists in the specific appearance element through the graphic objects overlaid with the appearance element.

Next, when indication information is received, the reception terminal outputs connection information from which brief supplementary information and detailed supplementary information about a specific appearance element can be downloaded at step S320.

More particularly, when an instruction to output supplementary information about a specific appearance element is received from a viewer through a device, such as a remote controller, a keyboard, or a mouse, the reception terminal may analyze metadata, output to brief supplementary information (see 521 of FIG. 6(b)), including a description of the appearance element in a brief memo form, and category information, and indicate whether a viewer will download the detailed supplementary information additionally (see 521 of FIG. 6(b)). For example, when a viewer selects a graphic object of a specific appearance element, the reception terminal outputs a link through which a brief description, category information, and an additional detailed description for the selected appearance element can be downloaded on its screen. Here, the reception terminal outputs the link in any one of the top, bottom, right, and left regions of the screen so that the viewing of content is not hindered.

Next, when an instruction to download the detailed supplementary information about the specific appearance element is received from a viewer through a device, such as a remote controller, a keyboard, or a mouse, the reception terminal accesses a server that provides the detailed supplementary information based on metadata, downloads the detailed supplementary information from the server, and stores the downloaded detailed supplementary information at step S330.

After the content is finished, the reception terminal informs a viewer whether or not the downloaded detailed supplementary information about the specific appearance element exists according to an instruction of the viewer at step S340.

Next, when an instruction to output the downloaded supplementary information is received from a viewer through a device, such as a remote controller, a keyboard, or a mouse, the reception terminal outputs the downloaded detailed supplementary information on its screen at step S350.

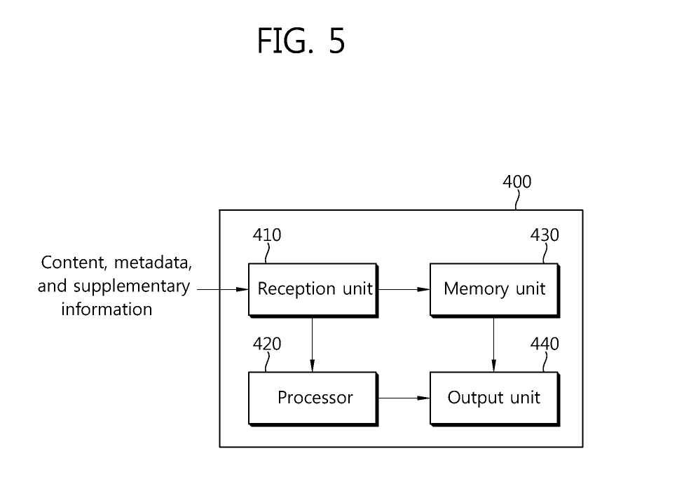

FIG. 5 is a block diagram showing a construction of the reception terminal 400 in the broadcasting system for providing supplementary information about content according to an embodiment of the present invention.

Referring to FIG. 5, the reception terminal 400 includes a reception unit 410, a processor 420, a memory unit 430, and an output unit 440.

The reception unit 410 receives at least one of content, metadata, and supplementary information. Here, the reception unit 410 may receive the content, metadata, or supplementary information over a broadcasting network or a communication network.

The processor 420 extracts an indicator indicating whether supplementary information about the content exists or not, based on the metadata received from the reception unit 410 and determines whether supplementary information about the content exists or not based on the extracted indicator.

Furthermore, the processor 420 controls supplementary information about an appearance element on the basis of the metadata so that the supplementary information is operated in association with the content. When an instruction is received from the output unit 440, the processor 420 performs control so that the instruction is performed.

The memory unit 430 stores the content, metadata or supplementary information transferred from the reception unit 410. Furthermore, when an instruction to download supplementary information about an appearance element appearing in the content is received from a viewer, the memory unit 430 accesses a server that provides the supplementary information, downloads the supplementary information about the appearance element, and stores the downloaded supplementary information. Since the downloaded supplementary information is stored in the memory unit 430, a viewer may obtain detailed information about the appearance element even after the content is finished.

The output unit 440 outputs supplementary information about an appearance element of content, in association with the content. That is, the output unit 440 outputs indication information, indicating that the supplementary information about the appearance element of the content in association with the content exists, based on metadata. Here, the indication information may be outputted so that a specific graphic object is overlaid on the appearance element. Furthermore, when an instruction to output the supplementary information on the basis of the indication information is received, the output unit 440 outputs connection information from which brief supplementary information and detailed supplementary information about the appearance element can be downloaded. Here, the brief supplementary information and the connection information may be outputted in any one of the top, bottom, right, and left regions of a screen in order to avoid the viewing of the content. After the content is finished, the output unit 440 outputs a screen displaying whether downloaded supplementary information exists or not. At this time, when an instruction to output the downloaded supplementary information is received from a viewer, the output unit 440 outputs the downloaded supplementary information to a screen.

FIG. 6 is a diagram schematically showing the screens of the reception terminal in which pieces of supplementary information about appearance elements of content are provided according to an embodiment of the present invention. FIG. 6(a) shows a screen that displays appearance elements whose supplementary information can be provided, and FIG. 6(b) shows a screen that provides brief supplementary information about a appearance element selected by a viewer.

Referring to FIG. 6(a), the reception terminal outputs graphic objects 501, 502, 503, and 504, each including number information, on respective appearance elements whose supplementary information can be provided to a screen. Furthermore, the reception terminal outputs the names of the appearance elements corresponding to the respective graphic objects 501, 502, 503, and 504 or pieces of brief attribute information 511 and 512 in an area of the screen.

For example, appearance elements whose supplementary information can be provided may include four appearance elements on which the graphic objects 501, 502, 503, and 504 are overlaid. Furthermore, a name (e.g., Kim So-eun and Ryu Jin) and attribute information (e.g., player) are provided in the appearance elements corresponding to the graphic object 501 and the graphic object 502.

Referring to FIG. 6(b), when a viewer selects the graphic object 501 by using a remote controller, a keyboard, or a mouse, the reception terminal outputs information 521 from which detailed supplementary information can be downloaded to the screen along with brief supplementary information 521 about a relevant appearance element on the basis of indication information indicated by the selected graphic object 501.

For example, if it is sought to obtain supplementary information about ‘Player Kim So-eun’, the graphic object 501 is selected. Next, brief supplementary information about ‘Player Kim So-eun’ is outputted to the screen in a memo form. Connection information about a server from which various types of supplementary information, such as detailed personal information, pertinent news, and pertinent advertisements related to ‘Player Kim So-eun’, can be additionally obtained, is outputted to the screen along with the brief supplementary information.

At this time, when a viewer gives an instruction to download (521) the detailed supplementary information, the reception terminal accesses the server that provides the relevant supplementary information, downloads the detailed supplementary information, and stores the downloaded detailed supplementary information so that the viewer can view the stored detailed supplementary information. Accordingly, the viewer may obtain the brief supplementary information and the detailed supplementary information about the appearance element corresponding to the graphic object 501.

The broadcasting system for providing supplementary information about content according to the present invention may provide supplementary information about content and the viewing of the content at the same time and also enable a viewer to view the supplementary information even after the viewing of the content is finished. Furthermore, the present invention provides the method of briefly displaying supplementary information on a screen of the reception terminal, downloading detailed supplementary information, and viewing the downloaded detailed supplementary information when a viewer views content in order not to hinder the viewing of content. Furthermore, a viewer may easily obtain supplementary information together with content viewing because remote control is possible by using a remote controller, a mouse, or a keyboard.

Furthermore, supplementary information about an appearance element appearing together with content can be provided along with the content in real time. Furthermore, the viewing of a content program is not hindered by minimizing a screen on which supplementary information about an appearance element is provided.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the appended claims and their equivalents.

What is claimed is:

1. A method of a reception terminal providing supplementary information about content, the method comprising:
receiving content and metadata;
extracting an indicator for indicating whether supplementary information about the content exists or not, from the metadata;
determining whether the supplementary information about the content exists or not based on the indicator;
outputting the supplementary information about an appearance element of the to content in association with the content based on the metadata;
accessing a server for providing the supplementary information about the appearance element based on the metadata when an instruction to download the supplementary information about the appearance element is received; and
downloading the supplementary information about the appearance element from the server and storing the downloaded supplementary information.

2. The method of claim 1, wherein outputting the supplementary information about the appearance element of the content comprises:
outputting indication information for indicating that the supplementary information about the appearance element exists in association with the content, based on the metadata; and
outputting brief supplementary information about the appearance element and connection information from which detailed supplementary information about the appearance element is downloadable, when the indication information is received.

3. The method of claim 2, wherein the indication information comprises a graphic object including information to identify the appearance element.

4. The method of claim 2, wherein the indication information is overlaid with any one part of the appearance element and outputted.

5. The method of claim 2, wherein the brief supplementary information and the connection information are outputted to any one of top, bottom, right, and left regions of an output screen of the content.

6. The method of claim 1, further comprising outputting an indication informing whether or not to download the supplementary information when the content is finished.

7. The method of claim 6, further comprising outputting the supplementary information according to whether an instruction to output the downloaded supplementary information exists or not.

8. The method of claim 1, wherein the metadata includes appearance element association information for providing the supplementary information about the appearance element in association with the content.

9. The method of claim 8, wherein the appearance element association information includes at least one of identifier (ID) information about the content, an indicator informing whether the supplementary information about the content exists or not, frame information and time information about the content, scene information about the content, ID information about the appearance element, name information about the appearance element, brief supplementary information about the appearance element, connection information from which detailed supplementary information about the appearance element is downloadable, category information about the supplementary information of the appearance element, and position information about the appearance element.

10. A transmission method for providing supplementary information about content in a broadcasting system, the transmission method comprising:
writing metadata including appearance element association information for providing supplementary information about an appearance element of content in association with the content;
producing the supplementary information about the appearance element based on the metadata; and
transmitting the content and the metadata.

11. The transmission method of claim 10, wherein the appearance element association information includes at least one of identifier (ID) information about the content, an indicator informing whether the supplementary information about the content exists or not, frame information and time information about the content, scene information about the content, ID information about the appearance element, name information about the appearance element, brief supplementary information about the appearance element, connection information from which detailed supplementary information about the appearance element is downloadable, category information about the supplementary information of the appearance element, and position information about the appearance element.

12. The transmission method of claim 10, wherein the metadata is transmitted in any one of a form multiplexed with the content, a streaming form, and a data file form.

13. A reception terminal for providing supplementary information about content, the reception terminal comprising:
a reception unit for receiving content and metadata;
a processor for extracting an indicator for indicating whether supplementary information about the content exists or not, from the metadata and determining whether the supplementary information about the content exists or not based on the indicator;
an output unit for outputting the supplementary information about an appearance element of the content in association with the content based on the metadata; and
a memory unit for accessing a server for providing the supplementary information based on the metadata when an instruction to download the supplementary information about the appearance element is received, downloading the supplementary information from the server, and storing the downloaded supplementary information.

14. The reception terminal of claim 13, wherein the output unit outputs indication information for indicating that the supplementary information about the appearance element exists, in association with the content based on the metadata.

15. The reception terminal of claim 14, wherein the output unit outputs brief supplementary information about the appearance element and connection information from which detailed supplementary information about the appearance element is downloadable, when the indication information is received.

16. The reception terminal of claim 14, wherein the indication information comprises a graphic object including information to identify the appearance element.

17. The reception terminal of claim 14, wherein the indication information is overlaid with any one part of the appearance element and outputted.

18. The reception terminal of claim 15, wherein the brief supplementary information and the connection information are outputted to any one of top, bottom, right, and left regions of an output screen of the content.

19. The reception terminal of claim 13, wherein the output unit outputs an indication informing whether or not to download the supplementary information when the content is finished.

20. The reception terminal of claim 19, wherein the output unit outputs the supplementary information according to whether an instruction to output the downloaded supplementary information exists or not.
